(19) United States
(12) Patent Application Publication
(10) Pub. No.: US 2011/0063656 A1
(43) Pub. Date: Mar. 17, 2011

(54) IMAGE DATA SIGNAL TRANSMISSION APPARATUS AND IMAGE DATA SIGNAL TRANSMISSION SYSTEM

(75) Inventor: Yoshinori AWATA, Kanagawa (JP)

(73) Assignee: FUJI XEROX CO., LTD., Tokyo (JP)

(21) Appl. No.: 12/728,744

(22) Filed: Mar. 22, 2010

(30) Foreign Application Priority Data
Sep. 14, 2009 (JP) 2009-211213

(51) Int. Cl. G06F 3/12

(52) U.S. Cl. 358/1.15

(57) ABSTRACT

An image data signal transmission apparatus includes plural circuit elements, a configuration unit, an instruction receiving unit and a signal transmission unit. The configuration unit combines ones of the plural circuit elements to configure one of plural kinds of signal transmission circuits which have different transmission characteristics from each other and which transmit a signal to a signal transmission line. The instruction receiving unit receives an instruction indicating the one of the plural types of signal transmission circuits as a circuit to be configured. The signal transmission unit causes the one of the signal transmission circuits, which is configured by the configuration unit in accordance with the instruction received by the instruction receiving unit, to transmit an image data signal.

### CROSS-REFERENCE TO RELATED APPLICATIONS

This application is based on and claims priority under 35 USC 119 from Japanese Patent Application No. 2009-211213 filed Sep. 14, 2009.

### BACKGROUND

1. Technical Field

The present invention relates to an image data signal transmission apparatus and image data signal transmission system.

2. Related Art

A system has been employed widely in which image data is transmitted from a computer to a printer to thereby print an image. One of the computers for use in the system is configured to execute image data processing on the software basis, and another one of the computers causes a hardware device for image data processing to execute the image data processing.

### SUMMARY

According to an aspect of the invention, an image data signal transmission apparatus includes plural circuit elements, a configuration unit, an instruction receiving unit and a signal transmission unit. The configuration unit combines ones of the plural circuit elements to configure one of plural kinds of signal transmission circuits which have different transmission characteristics from each other and which transmit a signal to a signal transmission line. The instruction receiving unit receives an instruction indicating the one of the plural types of signal transmission circuits as a circuit to be configured. The signal transmission unit causes the one of the signal transmission circuits, which is configured by the configuration unit in accordance with the instruction received by the instruction receiving unit, to transmit an image data signal.

### BRIEF DESCRIPTION OF THE DRAWINGS

Exemplary embodiments will be described in detail below based on the accompanying drawings, wherein:

FIG. 1 is a diagram showing an example of the configuration of a printing system;

FIG. 2 is a diagram showing an example of the configuration of a printer connecting board according to a first exemplary embodiment;

FIG. 3 is a diagram showing an example of circuits which are configured in respective reconfigurable devices;

FIGS. 4A to 4D are diagrams showing examples of characteristic adjusting circuit which are defend by candidate data;

FIGS. 5A and 5B are diagrams showing connection examples of reference resistors in the case where a device referring to a resistance value is used;

FIG. 6 is a diagram showing a specific example of a first board;

FIG. 7 is a diagram showing a specific example of a second board;

FIG. 8 is a diagram showing another example of the circuits, which are configured in the respective reconfigurable devices;

FIG. 9 is a flowchart showing a process executed by a device controller in conjunction with a first reconfigurable device and a process executed by a second reconfigurable device, in a calibration process;

FIGS. 10A to 10C are diagrams showing examples of temporal waveform of a test signal;

FIG. 11 is a diagram showing an example of a signal quality determination circuit that detects a waveform having a step portion; and

FIG. 12 is a diagram for explaining a process executed by the signal quality determination circuit shown in FIG. 11.

### DETAILED DESCRIPTION

### 1. Printing System

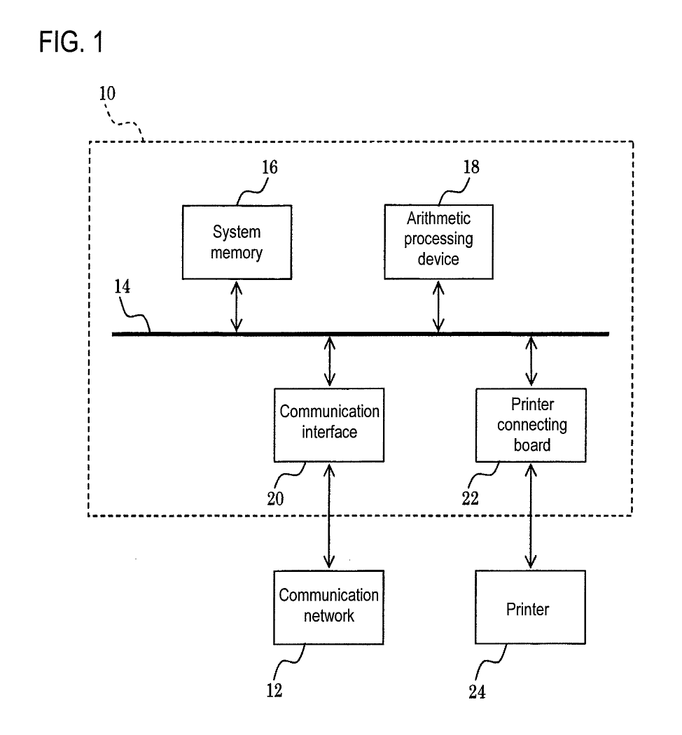

FIG. 1 shows an example of the configuration of a printing system according to an exemplary embodiment of the invention. The printing system includes a communication network 12, a print processing computer 10 connected to the communication network 12, and a printer 24 connected to the print processing computer 10.

Respective devices provided in the print processing computer 10 are connected to a data bus 14 and transmit and receive data to and from an arithmetic processing device 18. The arithmetic processing device 18 executes an arithmetic process for date obtained via the data bus 14, in accordance with a program stored in a system memory 16.

The printing process executed by the print processing computer 10 will be explained. The arithmetic processing device 18 executes a print process program stored in the system memory 16 and obtains PDL data which is described in the page description language from another computer via the communication network 12 and a communication interface 20. Then, the arithmetic processing device 18 converts the PDL data thus obtained into image data representing colors of respective pixels and positional coordinates of the respective pixels, then executes a compression process, a color-space conversion process and the like for the image data, and stores the resultant image data in the system memory 16.

In place of obtaining the PDL data from another computer and converting it into the image data in the above described manner, the arithmetic processing device 18 may executes a program for generating image data and store the generated image data into the system memory 16.

The arithmetic processing device 18 outputs the image data stored in the system memory 16 to a printer connecting board 22. The printer connecting board 22 executes a pre-printing data process to convert the image data into data suited to the characteristics of the printer 24 and outputs the image data thus processed to the printer 24. The printer 24 executes the printing process based on the image data obtained from the print processing computer 10.

### 2. Printer Connecting Board

### (1) Hardware Configuration

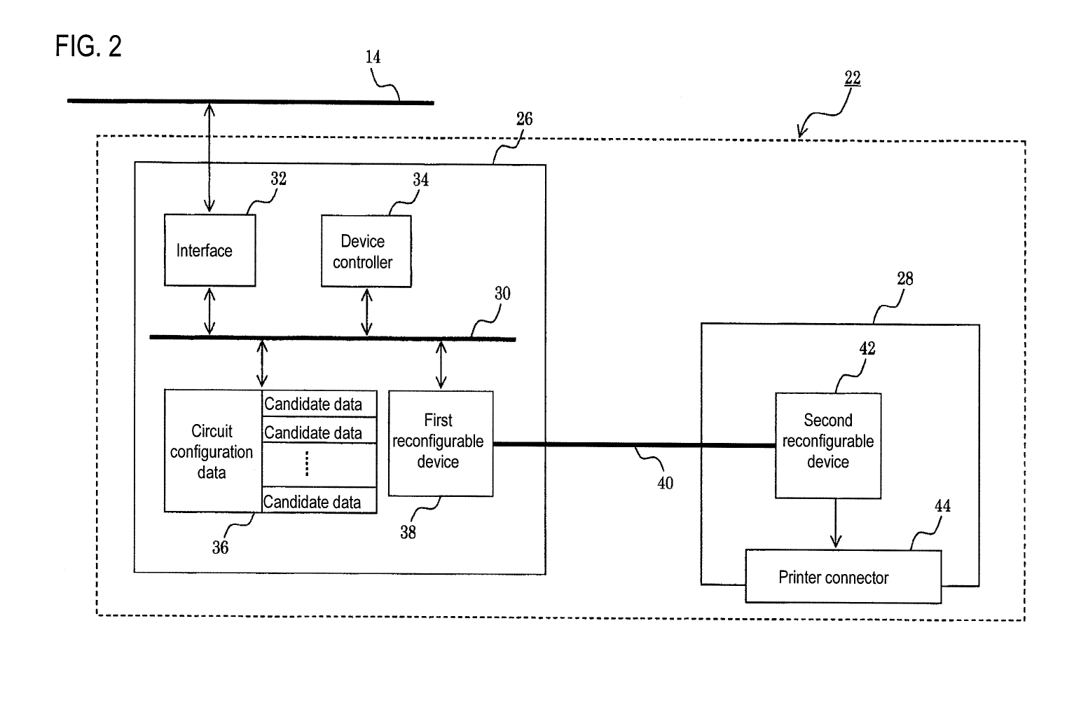

FIG. 2 shows an example of the configuration of the printer connecting board 22 according to a first exemplary embodiment of the invention. The printer connecting board 22 includes a first board 26 and a second board 28 for executing the pre-printing data process in a shared manner. A first reconfigurable device 38 mounted on the first board 26 is connected to a second reconfigurable device 42 mounted on the second board 28 via an image data signal transmission line 40. The image data signal transmission line 40 transmits data transited and received (exchanged) between the first reconfigurable device 38 and the second reconfigurable device 42. Since the first reconfigurable device 38 and the second reconfigurable device 42 are connected to each other via the image data signal transmission line 40, a series of the pre-printing data process is executed in combination with processes of the two devices. The number of the signal transmission lines 40 may be selected in accordance with the processes executed by the respective boards and the hardware configurations of the respective boards, etc.

A local data bus 30 provided in the first board 26 is connected to the data bus 14 via an interface 32. Respective devices mounted on the first board 26 are connected to the local data bus 30. The first reconfigurable device 38 obtains the image data from the data bus 14 via the interface 32 and the local data bus 30 under the control of a device controller 34.

The first reconfigurable device 38 and the second reconfigurable device 42 execute the pre-printing data process for the image date under the control of the device controller 34. A printer connector 44 is connected to the second board 28. The image data thus subjected to the pre-printing data process is output to the printer 24 from the printer connector 44.

Since the printer connecting board 22 is configured by the two divided boards in this manner, the printer connecting board 22 may be mounted in various manners such as the two boards are disposed in a laminated manner or the two boards are disposed on the same plane. Thereby, a degree of freedom concerning the mounting of the printer connecting board 22 can be enhanced.

### (2) Circuit Configuration Process

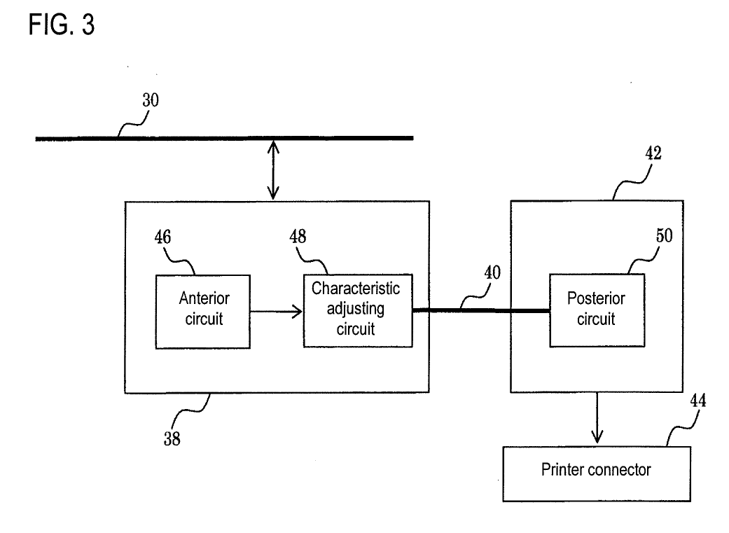

Explanation will be given as to a process executed by the device controller 34 for the first reconfigurable device 38 and the second reconfigurable device 42. Each of the first reconfigurable device 38 and the second reconfigurable device 42 includes plural circuit elements, and can configure any of plural kinds of circuits by changing settings of functions of the circuit elements and connection states among the circuit elements. The device controller 34 configures, in the first reconfigurable device 38 and the second reconfigurable device 42, circuits according to circuit configuration data stored in a circuit configuration memory 36. The circuit configuration process may be executed at a time of an activation process such as power supply from a power source. FIG. 3 shows an example of the circuits which are configured in the respective devices. In the figure, constituent elements identical to those of FIG. 2 are referred to by the same reference numerals, and explanation thereof will be omitted.

The device controller 34 configures an anterior circuit 46 and a characteristic adjusting circuit 48 in the first reconfigurable device 38 and a posterior circuit 50 in the second reconfigurable device 42 based on the circuit configuration data stored in the circuit configuration memory 36. The characteristic adjusting circuit 48, which is configured based on the circuit configuration data, may be changed by user's operation as will be described later.

The anterior circuit 46 and the posterior circuit 50 execute the pre-printing data process in the shared manner. That is, the pre-printing data process is divided into a anterior-stage process and a posterior-stage process, the anterior circuit 46 executes the anterior-stage process, and the posterior circuit 50 executes the posterior-stage process. An output signal of the anterior circuit 46 is input to the posterior circuit 50 via the characteristic adjusting circuit 48 and the image data signal transmission line 40. The characteristic adjusting circuit 48 compensates variation in transmission characteristics of the image data signal transmission line 40, and details thereof will be described later.

If image data to be processed is one having been subjected to a compression process, the pre-printing data process may include an image data expansion process. If the resolution of an image represented by image data to be processed is not suited to the process of the printer 24, the pre-printing data process may include a resolution conversion process. Further, in order to make the image date be suite suitable for the process of the printer 24, the pre-printing data process may include a filtering process for reducing a predetermined data component, a tone adjusting process for adjusting the tone characteristics of an image, a rotation process for changing the direction of an image, and the like.

The device controller 34 outputs the image data obtained from the interface 32 to the anterior circuit 46. The anterior circuit 46 executes the anterior-stage process for the image data and outputs the image data thus processed to the characteristic adjusting circuit 48. The characteristic adjusting circuit 48 outputs the image data to the image data signal transmission line 40. The posterior circuit 50 executes the posterior-stage process for the image data transmitted via the image data signal transmission line 40. The posterior circuit 50 outputs the image data to the printer 24 via the printer connector 44.

### (3) Implementation of Printer Connecting Board and Characteristic Adjusting Circuit

The printer connecting board 22 shown in FIG. 2 may be implemented in the print processing computer 10 in the following manner. For example, in the case where the data bus 14 of the print processing computer 10 is provided with slots for connection of peripheral device boards, the first board 26 is fixed to the print processing computer 10 while the interface 32 of the first board 26 is connected to the slot. Then, the second board 28 is stacked on the first board 26 and fixed to thereby fix the second board 28 to the print processing computer 10 via the first board 26.

In the case where the print processing computer 10 is provided with a space in which plural peripheral device boards are stacked in parallel from one another in the thickness direction, and the slots are provided so as to realize such the arrangement of the peripheral device boards, the second board 28 may be disposed in a space adjacent to the first board 26 so that the second board 28 is stacked on the first board 26.

However, when another peripheral device board is disposed in adjacent to the first board 26, it becomes difficult to stack the second board 28 on the first board 26. Thus, the second board 28 may be disposed in such a position that the other peripheral device board is disposed between the second board 28 and the first board 26. In this case, a substrate of the second board 28 may be formed so as to be fitted into the slot provided in the position with the second board 28 being kept to be in the electrically insulating state. Then, the second board 28 formed in this manner is fitted into the slot, and the slot may be used as a member for supporting the first board 26.

In this manner, the printer connecting board 22 according to the exemplary embodiment is configured so that the first board 26 is connected to the second board 28 via the image data signal transmission line 40. Therefore, the disposed position of the second board 28 may be changed according to the mounting states of other peripheral device boards.

When a positional relation between the first board 26 and the second board 28 is different, the length, the shape, and the like of the image data signal transmission line 40 also become different, and thus, the transmission characteristics of the image data signal transmission line 40 becomes different. Accordingly, the temporal waveform of the signal received by the second reconfigurable device 42 may not satisfy a predetermined condition, depending on the mounting state of the first board 26 and the second board 28.

Then, the characteristic adjusting circuit 48 configured in the first reconfigurable device 38 changes its circuit configuration in accordance with a user's operation so as to change its output characteristics. The arithmetic processing device 18 of the print processing computer 10 executes a circuit selection program for requesting the user to select one of predetermined circuit configurations with respect to the characteristic adjusting circuit 48. The arithmetic processing device 18 executes a process for requesting the user to select one of plural pieces of candidate data stored in the circuit configuration memory 36 as the process for requesting the user to select one of the predetermined circuit configurations. Each candidate data defines the configuration of the characteristic adjusting circuit 48.

The characteristic adjusting circuit 48 includes a buffer amplifier, for example. The output characteristics of the characteristic adjusting circuit 48 with respect to the image data signal transmission line 40 is adjusted by changing a connection state of peripheral elements of the buffer amplifier and element constants of the peripheral elements. The circuit configurations of the characteristic adjusting circuit 48 are defined by the plural pieces of candidate data, respectively. The plural pieces of candidate data define different connection states, different element constants, and the like with respect to the peripheral elements of the buffer amplifier, respectively. Thus, the characteristic adjusting circuits 48, which are configured based on the different candidate data, have different output characteristics with respect to the image data signal transmission line 40.

The arithmetic processing device 18 transmits information indicating the selected candidate data to the device controller 34. The device controller 34 reads the candidate data indicated by the information from the circuit configuration memory 36 so as to configure the characteristic adjusting circuit 48.

After the characteristic adjusting circuit 48 is configured based on the candidate data, the device controller 34 may change the circuit configuration data so that the same circuit is configured in the circuit configuration process, which will be executed at a time of the next activation process.

The circuit selection program may be executed in the case of adjusting the temporal waveform of the signal, which is to be received by the second reconfigurable device 42 via the image data signal transmission line 40. In this case, the user observes the signal received by the second reconfigurable device 42 by using a measurement device or the like. Then, the characteristic adjusting circuit 48 is configured based on an operation which is involved in execution of the circuit selection program so that the temporal waveform of the signal to be observed satisfies the predetermined condition. Thereby, the characteristic adjusting circuit 48 is configured so that the temporal waveform of the signal received by the second reconfigurable device 42 satisfies the predetermined condition.

The circuit selection program may be executed in maintenance and checking of the printer connecting board 22. For example, in the case of confirming as to whether or not there is an abnormality in a signal output from the characteristic adjusting circuit 48, the circuit selection program may be executed so that the characteristic adjusting circuit 48 is configured to form a predetermined circuit for performing the maintenance and checking operation.

### (4) Examples of Characteristic Adjusting Circuits Defined by Candidate Data

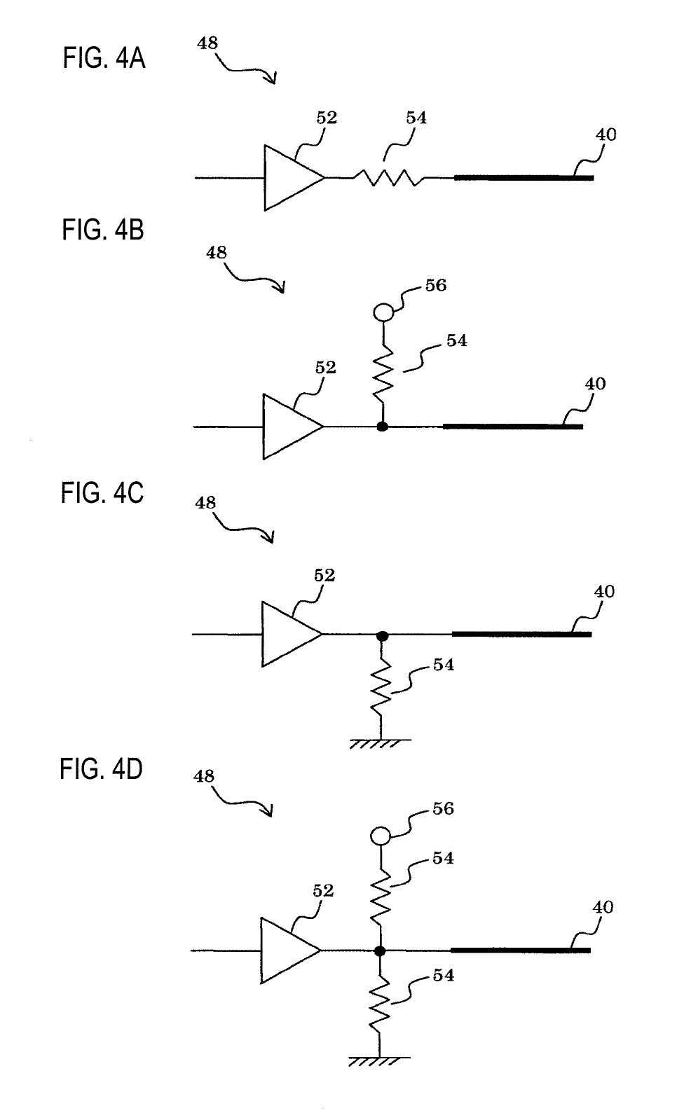

FIGS. 4A to 4D show examples of the characteristic adjusting circuit 48 defend by the candidate data. FIG. 4A shows an example of the circuit configuration in which a resistor 54 is connected in series between an output terminal of a buffer amplifier 52 and the image data signal transmission line 40. FIG. 4B shows an example of the circuit configuration in which the image data signal transmission line 40 is connected to the output terminal of the buffer amplifier 52, and the resistor 54 is connected between the output terminal of the buffer amplifier 52 and a power supply terminal 56. FIG. 4C shows an example of the circuit configuration in which the image data signal transmission line 40 is connected to the output terminal of the buffer amplifier 52, and the resistor 54 is connected between the output terminal of the buffer amplifier 52 and the ground. FIG. 4D shows an example of the circuit configuration in which the image data signal transmission line 40 is connected to the output terminal of the buffer amplifier 52, the resistor 54 is connected between the output terminal of the buffer amplifier 52 and the power supply terminal 56, and another resistor 54 is connected between the output terminal of the buffer amplifier 52 and the ground.

Alternatively, for each of the circuits shown in FIGS. 4A to 4D, plural pieces of candidate data which set the resistors 54 to have different resistance values may be stored in the circuit configuration memory 36, such as (i) pieces of candidate data for the circuit shown in FIG. 4A which set the resistor 54 to have resistance values of 10Ω, 50Ω, 100Ω, . . . , and (ii) pieces of candidate data for the circuit shown in FIG. 4B which set the resistor 54 to have resistance values of 10Ω, 50Ω, 100Ω, . . . .

Further, plural pieces of candidate data which set different driving properties of the buffer amplifier 52 may be stored for each of the circuits shown in FIGS. 4A to 4D. The driving property of the buffer amplifier 52 may be defined by the allowable current or the like at the output terminal of the buffer amplifier 52.

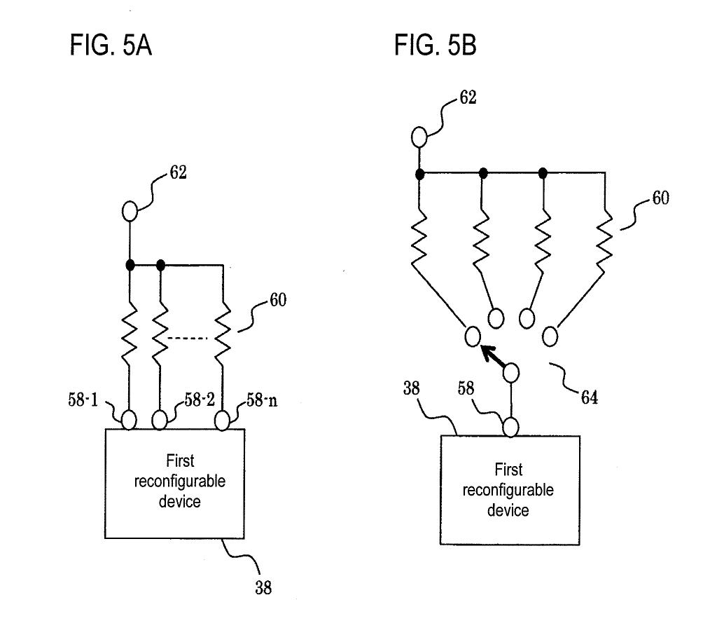

In the case where a device which refers to a resistance value is used as the first reconfigurable device 38, the following candidate data may be stored in the circuit configuration memory 36. The device which refers to the resistance value has plural (n) reference terminals 58-1 to 58-n connected to one terminals of reference resistors 60 as shown in FIG. 5A and adjusts the resistance value of the resistor included in the characteristic adjusting circuit 48 to be the same as the resistance value of the reference resistor 60 which is connected to selected one of the plural reference terminals. Examples of the device which refers to the resistance value include one in which other ends of the reference resistors 60 are connected to the reference voltage terminal 62 of the power supply terminal or the like and another one in which other ends of the reference resistors are grounded, for example. FIG. 5A shows the one in which the other ends of the reference resistors are connected to the reference voltage terminal 62.

In the case of using such a device, the reference resistors 60 having different resistance values may be connected to the respective reference terminals. For each of the circuits shown in FIGS. 4A to 4D, n pieces of candidate data which set a selected reference terminal to be the reference terminals 58-1 to 58-n, respectively may be stored in the circuit configuration memory 36, such as (i) for the circuit shown in FIG. 4A, candidate data which sets the selected reference terminal to be the reference terminal 58-1, candidate data which sets the selected reference terminal to be the reference terminal 58-2, . . . candidate data which sets the selected reference terminal to be the reference terminal 58-n, (ii) for the circuit shown in FIG. 4B, candidate data which sets the selected reference terminal to be the reference terminal 58-1, candidate data which sets the selected reference terminal to be the reference terminal 58-2, . . . candidate data which sets the selected reference terminal to be the reference terminal 58-n, . . . .

Further, as shown in FIG. 5B, the following configuration may be adopted. That is, the single reference terminal 58 is provided as a reference terminal to be selected, and a selector switch 64 for connecting one end of one of the plural the reference resistors 60 to the reference terminal 58 is provided. In this case, when a user operates the selector switch 64, one of the reference resistors 60 is selected. Then, for example, for each of the circuits shown in FIGS. 4A to 4D, four pieces of candidate data which referring to a resistance value of the reference resistor 60 connected to the reference terminal 58 are stored in the circuit configuration memory 36.

Some of the plural pieces of candidate data stored in the circuit configuration memory 36 are selected by the user through execution of the circuit selection program. When different one of the candidate data is selected, the characteristic adjusting circuits 48 having a different output impedance with respect to the image data signal transmission line 40 is configured.

### (5) Specific Example of Printer Connecting Board

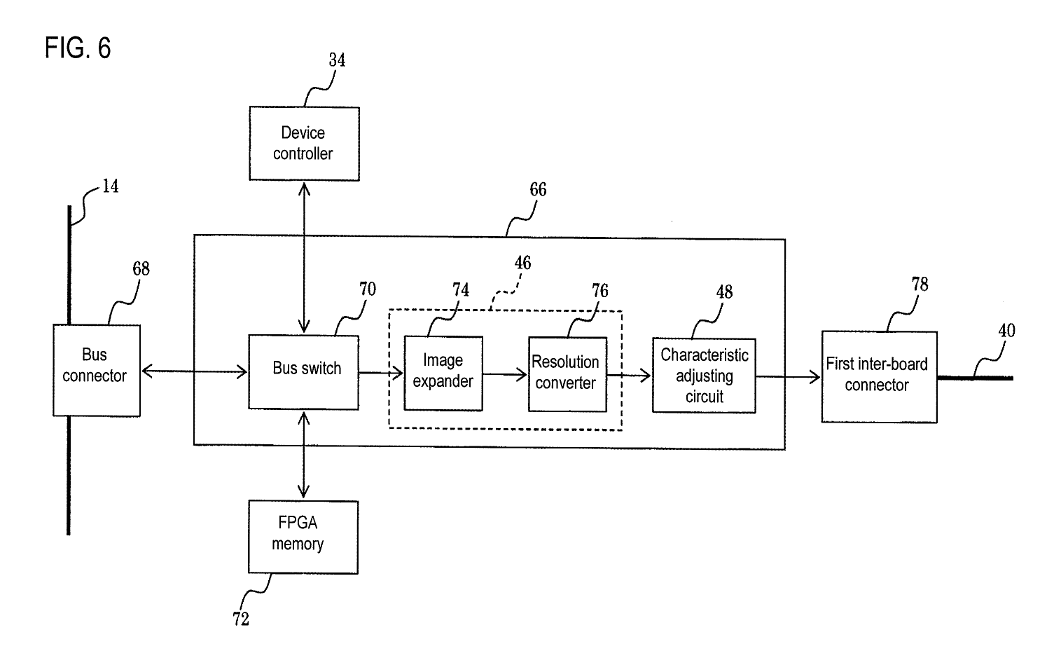

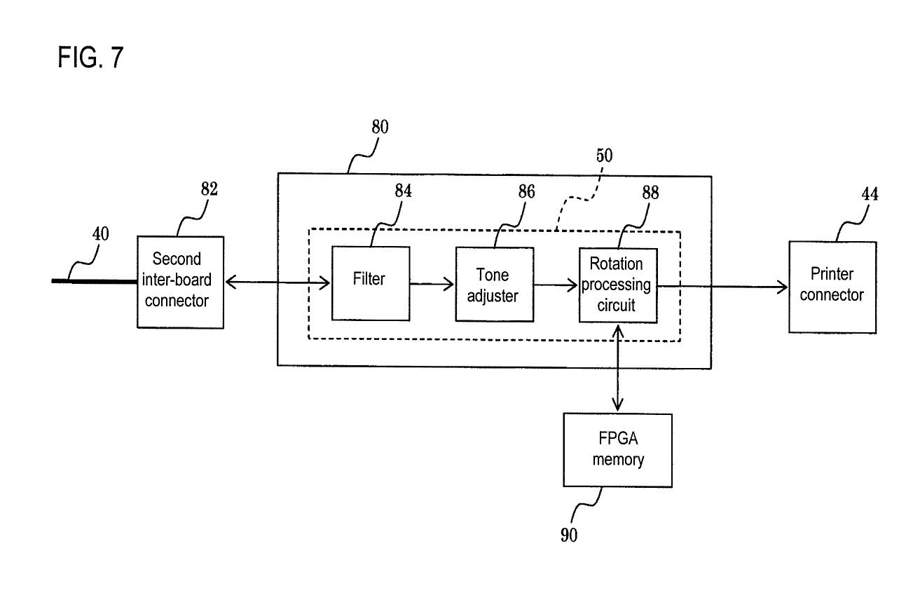

A specific example of the printer connecting board 22 will be described below. It is assumed that the compression process has been performed for the image data to be processed. FIG. 6 shows the configuration of the first board 26, and FIG. 7 shows the configuration of the second board 28. FIGS. 6 and 7 show a state after the device controller 34 configures a circuit according to the circuit configuration data. In FIGS. 6 and 7, constituent elements identical to those in FIGS. 2 and 3 are referred to by the common reference numerals, and description thereon will be omitted.

An FPGA (Field Programmable Gate Array) 66 corresponds to the first reconfigurable device 38 of FIG. 2. A bus connector 68 corresponds to the interface 32 of FIG. 2, and a bus switch 70 corresponds to the local data bus 30 of FIG. 2. The bus connector 68 fits into a slot such as a PCI Express provided in the data bus 14 of the print processing computer 10 to connect the FPGA 66 to the data bus 14.

The bus switch 70 performs switching connection among the device controller 34, the bus connector 68, the anterior circuit 46 and an FPGA memory 72. For example, when the device controller 34 reads data from the data bus 14 or outputs data to the data bus 14, the bus switch 70 connects the device controller 34 to the bus connector 68. When the device controller 34 stores data in the FPGA memory 72 or reads data from the FPGA memory 72, the bus switch 70 connects the device controller 34 to the FPGA memory 72. When the device controller 34 outputs data to the anterior circuit 46, the bus switch 70 connects the device controller 34 to the anterior circuit 46.

The FPGA memory 72 functions as the circuit configuration memory 36 of FIG. 2 and also functions as a buffer memory which stores image data input to the anterior circuit 46.

The anterior circuit 46 includes an image expander 74 and a resolution converter 76. The image expander 74 performs an image expansion process for image data and outputs the processed image data to the resolution converter 76. The resolution converter 76 converts the resolution of the image data to be processed in accordance with the process of the printer 24, and outputs the converted image data to the characteristic adjusting circuit 48.

A first inter-board connector 78 connects the FPGA 66 to the image data signal transmission line 40, and a second inter-board connector 82 connects the image data signal transmission line 40 to an FPGA 80. The characteristic adjusting circuit 48 outputs the image data to the FPGA 80 via the first inter-board connector 78, the image data signal transmission line 40 and the second inter-board connector 82.

The FPGA 80 corresponds to the second reconfigurable device 42 of FIG. 2. The posterior circuit 50 configured in the FPGA 80 includes a filter 84, a tone adjuster 86, and a rotation processing circuit 88. The filter 84 performs a filtering process for the image data and outputs the processed image data to the tone adjuster 86. The tone adjuster 86 adjusts the tone of the image data in accordance with the characteristics of the printer 24, and outputs the adjusted image data to the rotation processing circuit 88. If it is necessary to rotate the image at a time of printing the image on a paper, the rotation processing circuit 88 performs a rotation process for the image data and outputs the processed image data to the printer connector 44. The rotation process performs a coordinate conversion process for respective pixels. Thus, the rotation processing circuit 88 stores the image data into a FPGA memory 90 and executes the rotation process for the stored data.

The printer connecting board 22 according to the exemplary embodiment stores the image data to be processed in the FPGA memory 72 serving as a buffer memory and stores data to be subjected to the rotation process in the FPGA memory 90. In this manner, the FPGA for executing the pre-printing data process is divided into two pieces, and the FPGAs 66, 80 are respectively provided with the memories corresponding to the respective processes. Thereby, an amount of input/output information per one memory is reduced. Thus, the data transfer speed between the memory and the FPGA is increased as compared with the case where a single memory is used.

### 3. Printer Connecting Board for Executing Calibration Process

In the printer connecting board according to the first exemplary embodiment, the characteristic adjusting circuit 48 is reconfigured based on a user's operation. In the printer connecting board according to the second exemplary embodiment which will be described herein, the characteristic adjusting circuit 48 is reconfigured by a calibration process for configuring the characteristic adjusting circuit 48 based on signal transmission/reception between the first board 26 and the second board 28. Since the hardware configuration of the printer connecting board according to the second exemplary embodiment is same as that of the first exemplary embodiment, the description which has been made with reference to FIG. 2 will be referred to.

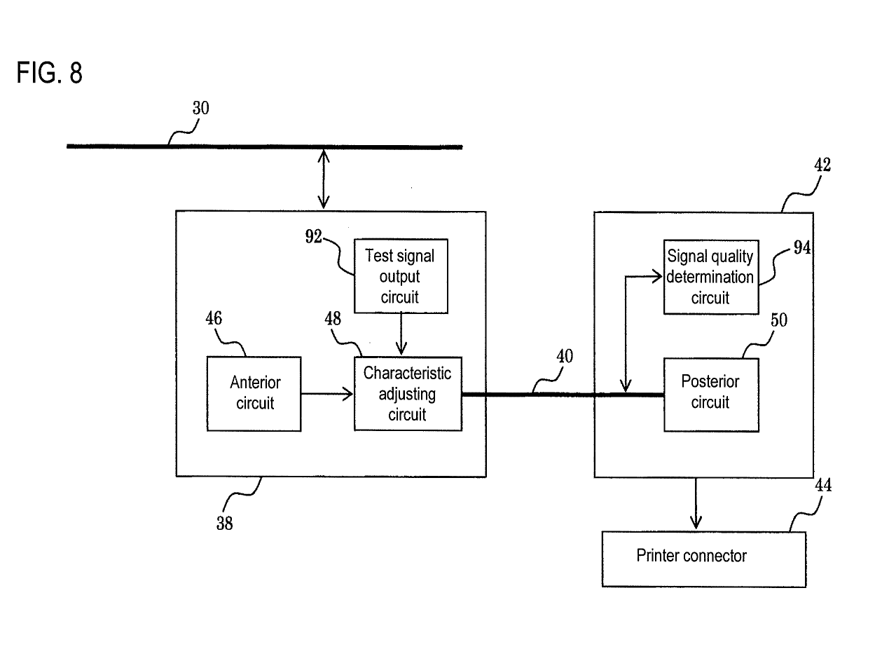

FIG. 8 shows circuits which are configured by the device controller 34 in the first reconfigurable device 38 and the second reconfigurable device 42. In FIG. 8, constituent elements identical to those in FIG. 3 are referred to by the common reference numerals, and description thereon will be omitted.

Based on the circuit configuration data stored in the circuit configuration memory 36, the device controller 34 configures the anterior circuit 46, the characteristic adjusting circuit 48 and a test signal output circuit 92 in the first reconfigurable device 38 and configures the posterior circuit 50 and a signal quality determination circuit 94 in the second reconfigurable device 42. The characteristic adjusting circuit 48, which is configured based on the circuit configuration data, is configured so as to be a predetermined initial circuit. The device controller 34 may change the configuration of the characteristic adjusting circuit 48 based on a calibration process. Furthermore, the device controller 34 may change the circuit configuration data so that a circuit which is same as the circuit thus changed is configured as the initial circuit of the characteristic adjusting circuit 48.

As circuits used in the calibration process, the device controller 34 configures the test signal output circuit 92 in the first reconfigurable device 38 and configures the signal quality determination circuit 94 in the second reconfigurable device 42. The test signal output circuit 92 outputs a test signal to the characteristic adjusting circuit 48, and the characteristic adjusting circuit 48 transmits the test signal. The signal quality determination circuit 94 checks the quality of the test signal, which is received by the second reconfigurable device 42.

In this manner, since the circuit used for the pre-printing data process is different from the circuit used for the calibration process, the first reconfigurable device 38 and the second reconfigurable device 42 may be configured by using a DRP (Dynamic Reconfiguration Processor) which are capable of dynamically changing the circuit configuration on the way of the data process. In this case, when the calibration process is executed, the device controller 34 configures the test signal output circuit 92 and the characteristic adjusting circuit 48 in the first reconfigurable device 38 and also configures the signal quality determination circuit 94 in the second reconfigurable device 42. Furthermore, when the pre-printing data process is executed, the device controller 34 configures the anterior circuit 46 in place of the test signal output circuit 92 and configures the posterior circuit 50 in place of the signal quality determination circuit 94.

On the other hand, in the case where the anterior circuit 46, the characteristic adjusting circuit 48 and the test signal output circuit 92 are configured together in the first reconfigurable device 38 and the posterior circuit 50 and the signal quality determination circuit 94 are configured together in the second reconfigurable device 42, a normal configurable device such as an FPGA may be used to hold the circuit configuration after the circuits are configured based on the circuit configuration data.

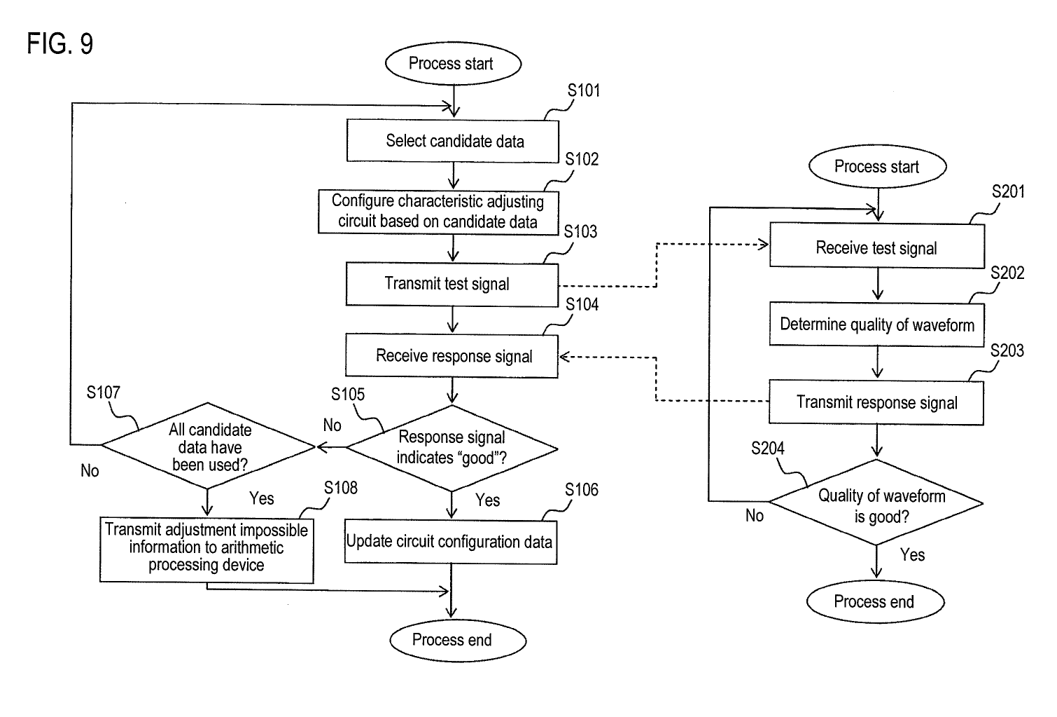

FIG. 9 shows an example of a flowchart showing a process executed by the device controller 34 in conjunction with the first reconfigurable device 38 and a process executed by the second reconfigurable device 42. Steps S101 to S108 of FIG. 9 show the process relating to the first reconfigurable device 38, and steps S201 to S204 of FIG. 9 show the process relating to the second reconfigurable device 42.

The calibration process may be executed whenever the device controller 34 configures the circuits based on the circuit configuration data and completes the circuit configuration process.

Alternatively, the calibration process may be executed when it is detected that the printer connecting board 22 is attached to the print processing computer 1. In this case, upon detection of connection of the printer connecting board 22 to the data bus 14, the arithmetic processing device 18 outputs command information instructing execution of the calibration process to the printer connecting board 22.

Also, the calibration process may be executed in accordance with a user's instruction. In this case, the arithmetic processing device 18 executes a program for requesting a user to perform an operation for starting the calibration process. When the user performs this operation, the arithmetic processing device 18 outputs the command information instructing the execution of the calibration process to the printer connecting board 22

The device controller 34 selects one of the plural pieces of candidate data stored in the circuit configuration memory 36 (S101), and configures the characteristic adjusting circuit 48 based on the selected candidate data (S102).

After configuring the characteristic adjusting circuit 48 based on the selected candidate data, the device controller 34 instructs the test signal output circuit 92 to output the predetermined test signal. Thereby, the test signal is transmitted to the second reconfigurable device 42 via the characteristic adjusting circuit 48 and the image data signal transmission line 40 (S103). A rectangular wave signal may be used as the test signal.

The second reconfigurable device 42 receives the test signal (S201). The signal quality determination circuit 94 configured in the second reconfigurable device 42 determines the quality of the test signal based on whether or not the temporal waveform of the test signal satisfies a predetermined condition (S202).

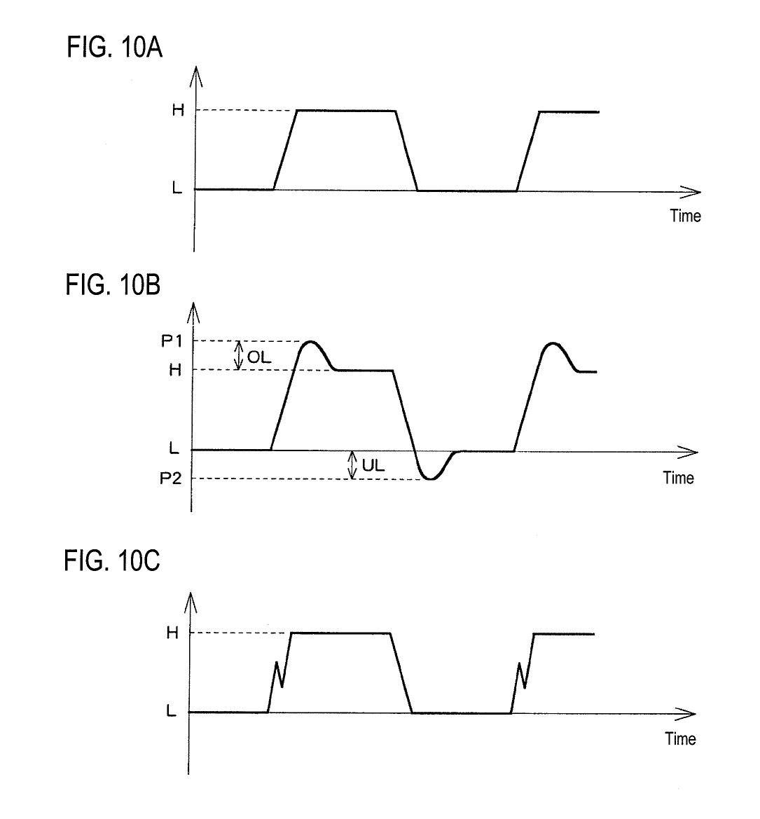

When the rectangular wave signal is used as the test signal, the signal quality determination circuit 94 may determine the quality of the test signal based on an overshoot level at rising of the test signal or an undershoot level at falling of the test signal. For example, when a rectangular wave signal shown in FIG. 10A is output from the characteristic adjusting circuit 48, an overshoot waveform exceeding a high level value H or an undershoot waveform lowering a low level value L may appear as shown in FIG. 10B.

It is assumed that an overshoot level OL is defined as a value obtained by subtracting the high level value H of the rectangular wave signal from a rising peak value P1. In this case, when the overshoot level OL exceeds a predetermined level, it may be determined that the quality of the test signal is not good. In a similar manner, it is assumed that an undershoot value UL is defined as a value obtained by subtracting a falling peak value P2 from the low level value L of the rectangular wave signal. When the undershoot level UL exceeds a predetermined level, it may be determined that the quality of the test signal is not good.

Further, as shown in FIG. 10C, it may be determined as to whether or not a waveform having a step portion appears in which the step portion arises in the middle of rising of the test signal. In this case, when the waveform having the step portion appears, it may be determined that the quality of the test signal is not good.

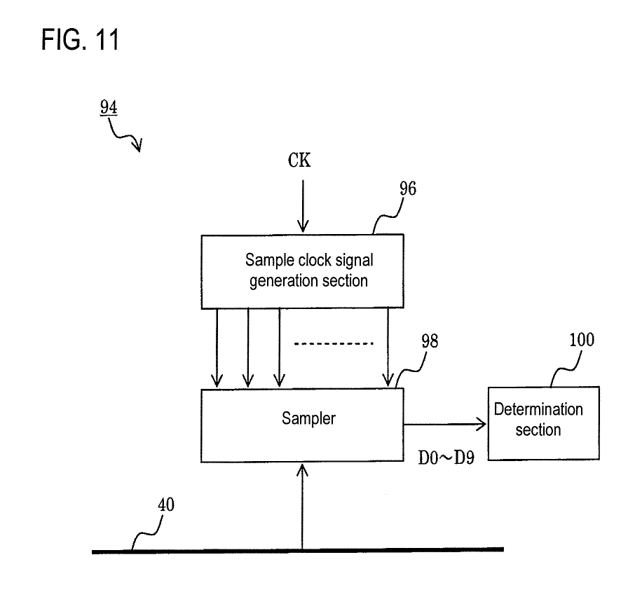

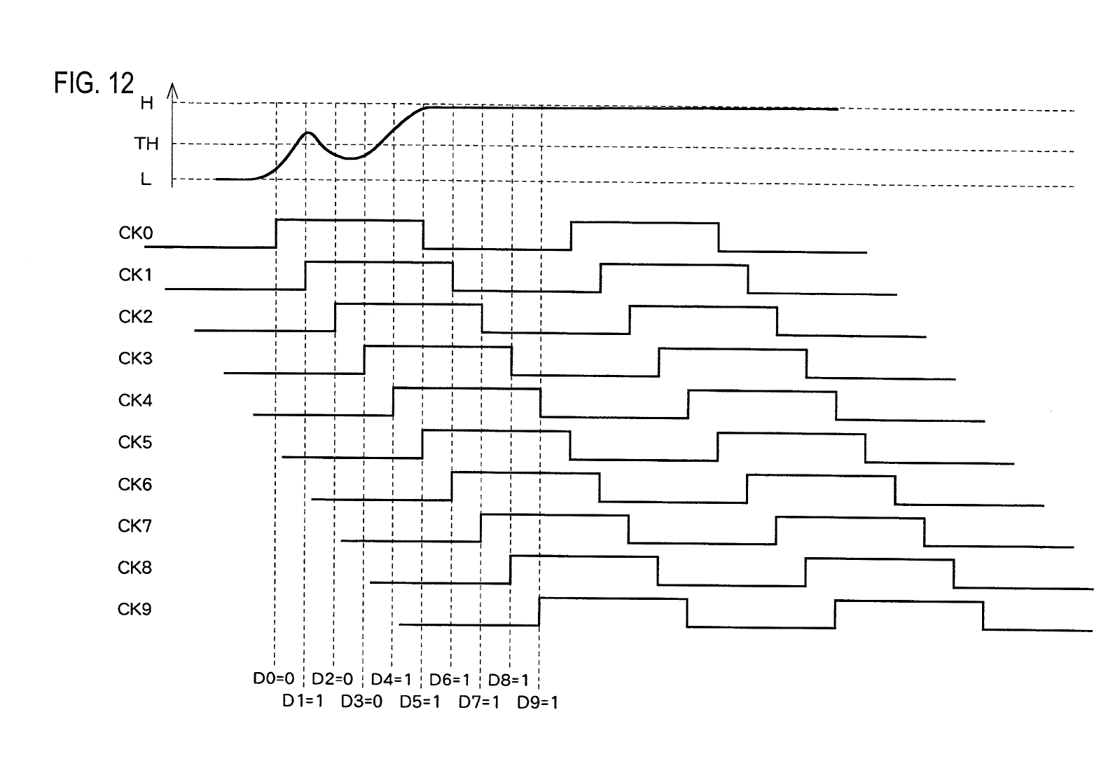

FIG. 11 shows an example of the signal quality determination circuit 94 which detects the waveform having the step portion. A sample clock signal generation section 96 receives a clock signal CK used in the second reconfigurable device 42. As shown in FIG. 12, the sample clock signal generation section 96 generates, based on the clock signal CK, sample clock signals CK0 to CK9 respectively having rising times shifted sequentially with a constant time interval and outputs the generated sample clock signals to a sampler 98.

The sampler 98 extracts values of a signal transmitted on the image data signal transmission line 40 shown in the uppermost part of FIG. 12, at the respective rising timings of the sample clock signals CK0 to CK9. Then, extraction values for determination are obtained based on the extracted values so that, when each extracted value exceeds a predetermined threshold value TH, the extraction value for determination is set to be 1 and when each extracted value is equal to or smaller than the predetermined threshold value TH, the extraction value for determination is set to be 0. The threshold value TH is larger than the low level value L of the rectangular wave signal and smaller than the high level value H thereof. Values shown in the lowermost part of FIG. 12 represent the extraction values for determination D0 to D9 obtained at the rising timings of the sample clock signals CK0 to CK9, respectively. In the example shown in FIG. 12, the extraction values for determination D0 to D9 are 0, 1, 0, 0, 1, 1, 1, 1, 1, 1, respectively.

The sampler 98 outputs the extraction values for determination to a determination section 100. If, when the extraction values for determination are referred to in order of D0 to D9, the extraction values for determination changes from 0 to 1 and all the succeeding extraction values for determination are 1, the determination section 100 determines that the waveform having the step portion does not occur. In contrast, if the extraction value for determination once changes from 0 to 1, then restores to 0 and thereafter changes to 1 again, the determination section determines that the waveform having the step portion occurs and determines that the quality of the test signal is not good. In the example of FIG. 12, after D1 shows 1, each of D2 and D3 shows 0, and thereafter D4 shows 1. Thus, the signal quality determination circuit 94 determines that the waveform having the step portion occurs and hence determines that the quality of the test signal is not good.

Although the description has been given with reference to the case where 10 types of extraction values for determination are generated using 10 types of sample clock signals. However, the number of sample clock signals and the number of extraction values for determination generated in correspondence thereto may be determined in accordance with the rising time of the rectangular waveform signal as the test signal.

The signal quality determination circuit 94 generates a response signal representing as to whether or not the quality of the test signal is good after determining the quality of the test signal and transmits the response signal to the first reconfigurable device 38 (S203). The signal quality determination circuit 94 confirms as to whether or not it is determined that the quality of the test signal is good (S204) and returns to the process at the step S201 when it is determined that the quality of the test signal is not good (S204). That is, the signal quality determination circuit receives the test signal again which is transmitted from the first reconfigurable device 38 (S201) and executes again the processes at the steps S202 and 5203. On the other hand, the signal quality determination circuit 94 terminates the process when determining that the quality of the test signal is good (S204).

After the device controller 34 instructs the test signal output circuit 92 to output the test signal, the device controller 34 obtains the response signal which is received by the first reconfigurable device 38 via the image data signal transmission line 40 (S104) and determines as to whether or not the response signal represents that the quality of the test signal is good (S105).

If the response signal represents that the quality of the test signal is good, the device controller 34 updates the circuit configuration data so that the circuit defined by the candidate data used in the nearest step S102 forms the initial circuit with respect to the characteristic adjusting circuit 48 (S106). On the other hand, if the response signal represents that the quality of the test signal is not good, it is determined as to whether or not all the candidate data stored in the circuit configuration memory 36 have been used (S107). If there remains candidate data which have not been used or selected, the candidate data having not been selected in the previously executed process at S101 is selected. On the other hand, if it is determined that all the candidate data have already been used, the device controller 34 transmits information indicating that adjustment is impossible to the arithmetic processing device 18 of the print processing computer 10 (S108) and terminates the process.

If the calibration process is completed after it is found that the quality of the test signal is good, the circuit configuration which makes the quality of the received signal at the posterior circuit 50 be good is employed. Thereafter, the image data signal is transmitted to the posterior circuit 50 from the anterior circuit 46 by using the circuit thus employed.

If the device controller 34 configures a circuit based on the circuit configuration data and executes the calibration process whenever the circuit configuration process is completed, the calibration process is executed irrespective of the configuration of the initial circuit. Therefore, the process at the step S106 may not be executed.

When the information indicating that adjustment is impossible is received from the device controller 34, the arithmetic processing device 18 may execute a program for displaying that the calibration process is not completed on a display section or the like which is connected to the print processing computer 10.

Alternatively, when the information indicating that the adjustment is impossible is received from the device controller 34, the arithmetic processing device 18 may execute the circuit selection program according to the first exemplary embodiment so as to execute the process for requesting a user to select one of the circuit configurations defined by the plural pieces of candidate data.

With such processes, the characteristic adjusting circuit 48 is configured so that the temporal waveform of the test signal received by the second reconfigurable device 42 satisfies the predetermined condition. Thus, the temporal waveform of the image data signal transmitted to the image data signal transmission line 40 satisfies the predetermined condition at the time of executing the pre-printing data process.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image data signal transmission apparatus, comprising:
a plurality of circuit elements;
a configuration unit that combines ones of the plurality of circuit elements to configure one of plural kinds of signal transmission circuits which have different transmission characteristics from each other and which transmit a signal to a signal transmission line;
an instruction receiving unit that receives an instruction indicating the one of the plural types of signal transmission circuits as a circuit to be configured; and
a signal transmission unit that causes the one of the signal transmission circuits, which is configured by the configuration unit in accordance with the instruction received by the instruction receiving unit, to transmit an image data signal.

2. An image data signal transmission apparatus, comprising:
a plurality of circuit elements;
a configuration unit that combines ones of the plurality of circuit elements to configure one of plural kinds of signal transmission circuits which have different transmission characteristics from each other and which transmit a signal to a signal transmission line; and
a signal transmission unit that causes the one of the signal transmission circuits, which is configured by the configuration unit, to transmits a signal, wherein
the signal transmission unit causes the signal transmission circuit, which is configured by the configuration unit, to transmit a test signal to a connecting destination apparatus via the signal transmission line,
when a response indicating that a quality of the test signal is good is not obtained from the connecting destination apparatus,
the configuration unit configures another one of the plural kinds of signal transmission circuits different from the one of the signal transmission circuits which transmitted the test signal, and
the signal transmission unit causes said another one of the signal transmission circuits to transmit again the test signal to the connecting destination apparatus,
when the response representing that quality of the test signal is good is obtained from the connecting destination apparatus, the configuration unit determines the signal transmission circuit, which is configured at a time of obtaining the response, as an image data signal transmission circuit, and
the signal transmission unit causes the image data signal transmission circuit to transmit an image data signal to the connecting destination apparatus.

3. The image data signal transmission apparatus according to claim 2, wherein the plural kinds of signal transmission circuits have different output impedance values with respect to the signal transmission line from each other.

4. An image data signal transmission system comprising:
a transmission apparatus that transmits a signal to a signal transmission line; and
a receiving apparatus that receives the signal transmitted from the transmission apparatus via the signal transmission line, wherein
the transmission apparatus includes
a plurality of circuit elements,
a configuration unit that combines ones of the plurality of circuit elements to configure one of plural kinds of signal transmission circuits which have different transmission characteristics from each other and which transmit a signal to a signal transmission line, and
a signal transmission unit that causes the one of the signal transmission circuits, which is configured by the configuration unit, to transmits the signal,
the signal transmission unit causes the signal transmission circuit, which is configured by the configuration unit, to transmit a test signal to the receiving apparatus via the signal transmission line,
when a response indicating that a quality of the test signal is good is not obtained from the receiving apparatus,
the configuration unit configures another one of the plural kinds of signal transmission circuits different from the one of the signal transmission circuits which transmitted the test signal, and
the signal transmission unit causes said another one of the signal transmission circuits to transmit again the test signal to the receiving apparatus,
when the response representing that quality of the test signal is good is obtained from the receiving apparatus, the configuration unit determines the signal transmission circuit, which is configured at a time of obtaining the response, as an image data signal transmission circuit, and
the signal transmission unit causes the image data signal transmission circuit to transmit an image data signal to the receiving apparatus.
